(19) United States
(12) Patent Application Publication
(10) Pub. No.: US 2013/0300396 A1
(43) Pub. Date: Nov. 14, 2013

(54) Start-up Circuit and Bandgap Voltage Generation Device

(71) Applicant: Yi-Kuang Chen, Taichung City (TW)

(72) Inventor: Yi-Kuang Chen, Taichung City (TW)

(21) Appl. No.: 13/584,832

(22) Filed: Aug. 14, 2012

(30) Foreign Application Priority Data
May 9, 2012 (TW) 101116501

(51) Int. Cl. G05F 3/02

(52) U.S. Cl. 323/313

(57) ABSTRACT

A start-up circuit for activating a bandgap voltage generation circuit is disclosed. The bandgap voltage generation circuit includes a bandgap input end, a first bandgap output end and a second bandgap output end. The start-up circuit includes a comparator having a first input end coupled to the first bandgap output end, a second input end coupled to the second bandgap output end, and an output end for outputting an output voltage, a first transistor including a gate coupled to the bandgap input end, a first source/drain coupled to a first system voltage, where a voltage of the gate is generated according to the output voltage, and a first resistor having an end coupled to a second source/drain of the first transistor, another end coupled to a second system voltage.

### BACKGROUND OF THE INVENTION

1. Field of the Invention

The present invention relates to a start-up circuit, and more particularly, to a start-up circuit for activating a bandgap voltage generation device according to a positive temperature coefficient voltage difference of the bandgap voltage generation device.

2. Description of the Prior Art

Analog circuits typically utilize a bandgap voltage generation device as a voltage or current source which is not influenced by the temperature to generate a reference voltage or current to ensure a normal operation of a power circuit or other circuits in the whole analog circuit. The bandgap voltage generation device is usually designed with a start-up circuit to activate the bandgap voltage generation device to generate a bandgap voltage, and the start-up circuit may automatically turn off after the bandgap voltage is generated to save power consumption of the whole analog circuit.

For example, please refer to FIG. 1, which is a schematic diagram of a traditional bandgap voltage generation device 10. The bandgap voltage generation device 10 comprises a start-up circuit 102 and a bandgap voltage generation circuit 100. The bandgap voltage generation device 10 utilizes a current mirror to combine a current IP having a Positive Temperature Coefficient (hereafter called PTC) with a current IN having a Negative Temperature Coefficient (hereafter called NTC) to obtain a bandgap voltage VBG having a zero temperature coefficient. In operation, a system voltage VDD turns on a transistor M0, and a gate of a transistor M0′ is shorted to a system voltage VSS to turn on the transistor M0′ to provide a small amount of voltage on a node A and a current IP having a PTC to activate the bandgap voltage generation circuit 100. However, as shown in FIG. 1, the bandgap voltage generation circuit 100 comprises two operational amplifiers having different amplification errors, such that a proportion between a PTC and an NTC of the bandgap voltage VBG may not be able to obtain the bandgap voltage VBG having the zero temperature coefficient, which may deteriorate a correctness of the bandgap voltage VBG.

Therefore, a bandgap voltage generation device having a single operational amplifier is provided to improve the correctness of the bandgap voltage VBG. Please refer to FIG. 2A, which is a schematic diagram of a bandgap voltage generation circuit 200. Connection relations between elements comprised by the bandgap voltage generation circuit 200 are shown in FIG. 2A. The bandgap voltage generation circuit 200 may form a steady feed back structure, an operational amplifier OP compares a negative input end (node A) with a positive input (node B) to control transistors M5, M6 to be turned on or off to adjust voltages of the nodes A, B. When the bandgap voltage generation circuit 200 reaches a steady state, the voltages VA and VB remain the same, the operational amplifier OP may further turn on a transistor M7 to generate the desired bandgap voltage VBG.

From a view point of circuit analysis, the current IM5 flowing on the transistor M5 may be a combination of a current IR2 flowing on a resistor R2 and a current IQ1 flowing on a transistor Q1, i.e. IM5=IR2+IQ1. The currents IR2, IQ1 may be respectively written as:

$$IR 2 = \frac{VBE 1}{R 2} , IQ 1 = \frac{{V}_{T} ln N}{R 3}$$

wherein N is a ratio of emitter areas of the transistors Q1 and Q2, i.e. Q2:Q1=N:1. A voltage V_{T} having a PTC (not shown in FIG. 2A) is a threshold voltage to turn on the transistor Q1. An emitter-base voltage difference VBE1 of the transistor Q1 has an NTC. Assume the transistors M5, M7 have the same size, i.e. the same W/L ratio, such that the current IM5 is equal to a current IM7 flowing on the transistor M7, the currents IM5, IM7 may be written as:

$$IM 5 = IM 7 = IR 2 + IQ 1 = \frac{VBE 1}{R 2} + \frac{{V}_{T} ln N}{R 3} \qquad ( 1 )$$

And the bandgap voltage VBG may be written as:

$$VBG = R 5 \times IM 7 = R 5 ( \frac{VBE 1}{R 2} + \frac{{V}_{T} ln N}{R 3} ) \qquad ( 2 )$$

As can be seen from formula (1) and formula (2), the bandgap voltage VBG is composed of the threshold voltage V_{T} having the PTC and the voltage difference VBE1 having the NTC. The desired bandgap voltage VBG maybe obtained by adjusting resistances of the resistors R2 and R3.

Please refer to FIG. 2B, which is a schematic diagram of a traditional bandgap voltage generation device 20. The bandgap voltage generation device 20 comprises a start-up circuit 202 and a bandgap voltage generation circuit 200. The start-up circuit 202 may compare a reference voltage VX with a voltage VIN of the operational amplifier OP to determine whether to activate the bandgap voltage generation circuit 200 to generate the bandgap voltage VBG.

In operation, when the reference voltage VX is greater than the voltage VIN, the bandgap voltage generation circuit 200 does not operate in an ideal operation region, and the desired bandgap voltage VBG may not be generated. The reference voltage VX may turn on transistors M11 and M13, and a current mirror M4 may copy a current on the transistor M13 to turn on transistors M2, M8 and M1. The transistor M1 may turn on the transistors M5, M6 and M7 to activate the bandgap voltage generation circuit 200. When the voltage VIN is greater than the reference voltage VX, the voltage VIN may turn on the transistors M12, M14 and M3, and the transistor M1 is turned off to turn off start-up circuit 202. When the voltage VIN is equal to the voltage VIP, the bandgap voltage generation circuit 200 has reached the steady state to generate the desired bandgap voltage VBG.

However, if timing is incorrect for turning on or off the start-up circuit 202, the bandgap voltage generation circuit 200 may not operate properly. For example, if the transistor M1 is turned off, but the transistor Q1 has not turned on, the bandgap voltage generation circuit 200 maybe stuck in a wrong steady state to generate the wrong bandgap voltage VBG. In another case, if one of the transistors Q1 and Q2 is turned on, but the transistor M1 has not turned off, the start-up circuit 202 may apply an improper bias to the bandgap voltage generation circuit 200 to generate the wrong bandgap voltage VBG.

### SUMMARY OF THE INVENTION

A start-up circuit is provided for activating a bandgap voltage generation device according to a positive temperature coefficient voltage difference of the bandgap voltage generation device.

In an aspect, a start-up circuit is disclosed for activating a bandgap voltage generation circuit. The bandgap voltage generation circuit comprises a bandgap input end, a first bandgap output end for providing a first negative temperature coefficient voltage and a second bandgap output end for providing a second negative temperature coefficient voltage. The start-up circuit comprises a comparator comprising a first input end coupled to the first bandgap output end, a second input end coupled to the second bandgap output end, and an output end for outputting an output voltage, a first transistor comprising a gate coupled to the bandgap input end, a first source/drain coupled to a first system voltage, wherein a voltage of the gate is generated according to the output voltage, and a first resistor comprising an end coupled to a second source/drain of the first transistor, another end coupled to a second system voltage.

In another aspect, a bandgap voltage generation device is disclosed. The bandgap voltage generation device comprises a bandgap voltage generation circuit comprising a bandgap input end, a first bandgap output end for providing a first negative temperature coefficient voltage and a second bandgap output end for providing a second negative temperature coefficient voltage, and a start-up circuit comprising a comparator comprising a first input end coupled to the first bandgap output end, a second input end coupled to the second bandgap output end, and an output end for outputting an output voltage, a first transistor comprising a gate coupled to the bandgap input end, a first source/drain coupled to a first system voltage, wherein a voltage of the gate is generated according to the output voltage, and a first resistor comprising an end coupled to a second source/drain of the first transistor, another end coupled to a second system voltage.

In further another aspect, a bandgap voltage generation device is disclosed. The bandgap voltage generation device comprises a bandgap voltage generation circuit comprising a bandgap input end, a first bandgap output end for providing a first negative temperature coefficient voltage, and a second bandgap output end for providing a second negative temperature coefficient voltage, and a start-up circuit coupled to the first bandgap output end and the second bandgap output end for activating the bandgap voltage generation circuit when a positive temperature coefficient voltage difference between the first negative temperature coefficient voltage and the second negative temperature coefficient voltage is determined to be zero.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a traditional bandgap voltage generation device.

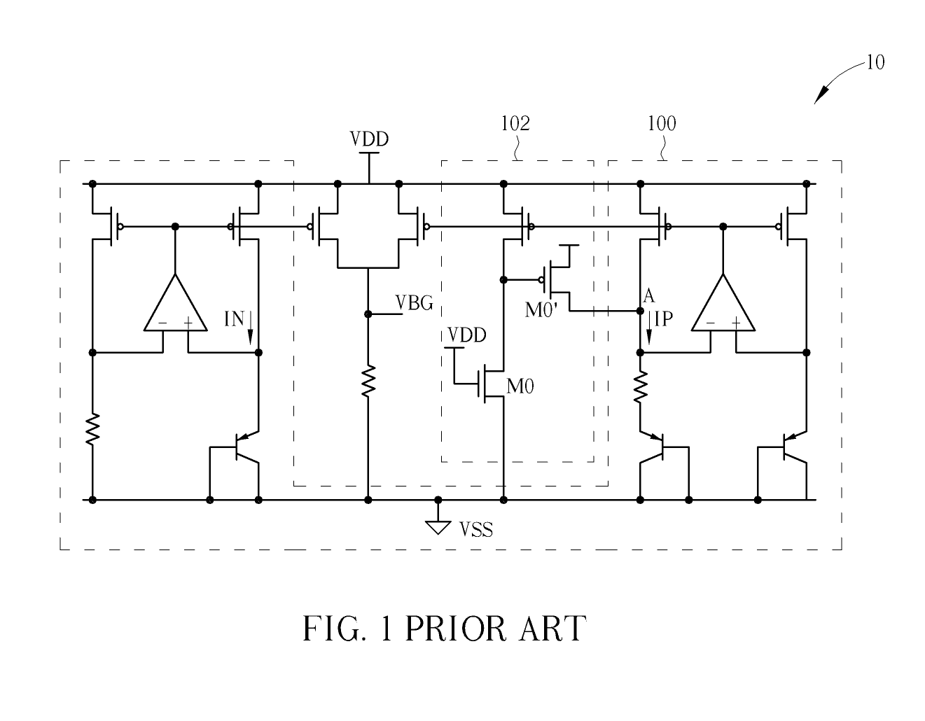

FIG. 2A is a schematic diagram of a traditional bandgap voltage generation circuit.

FIG. 2B is a schematic diagram of a traditional bandgap voltage generation device.

FIG. 3 is a schematic diagram of a start-up circuit according to an embodiment of the present invention.

FIG. 4 is a schematic diagram of a bandgap voltage generation circuit.

FIG. 5A is a voltage-time diagram of the NTC voltages on the nodes shown in FIG. 4.

FIG. 5B is a voltage-time diagram of the PTC voltage difference between the NTC voltage and the NTC voltage shown in FIG. 4.

FIG. 6 is a schematic diagram of a bandgap voltage generation device according to an embodiment of the present invention.

### DETAILED DESCRIPTION

In the specification and the claim of the present invention may use a particular word to indicate an element, which may have diversified names named by distinct manufacturers. The present invention distinguishes the element depending on its function rather than its name. The phrase comprising” used in the specification and the claim is to mean is inclusive or open-ended but not exclude additional, un-recited elements or method steps.” In addition, the phrase “coupled” is to mean any electrical connection in a direct manner or an indirect manner. Therefore, the description of a first device coupled to a second device” is to mean that the first device is connected to the second device directly or by means of connecting through other devices or methods in an indirect manner.

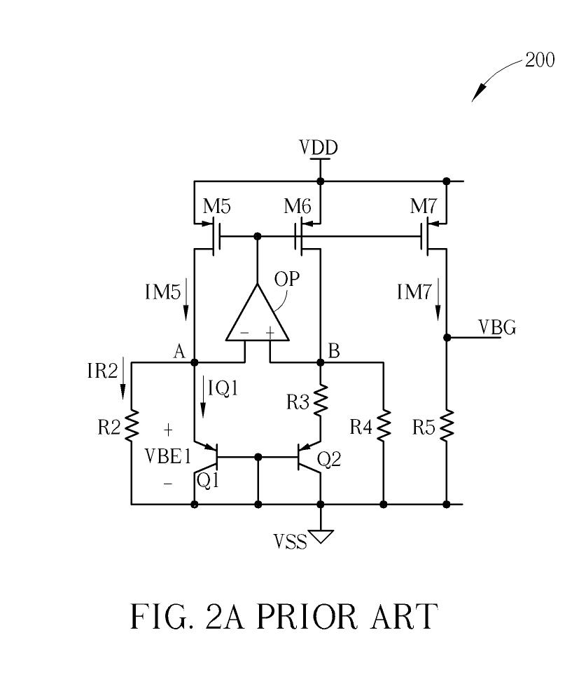

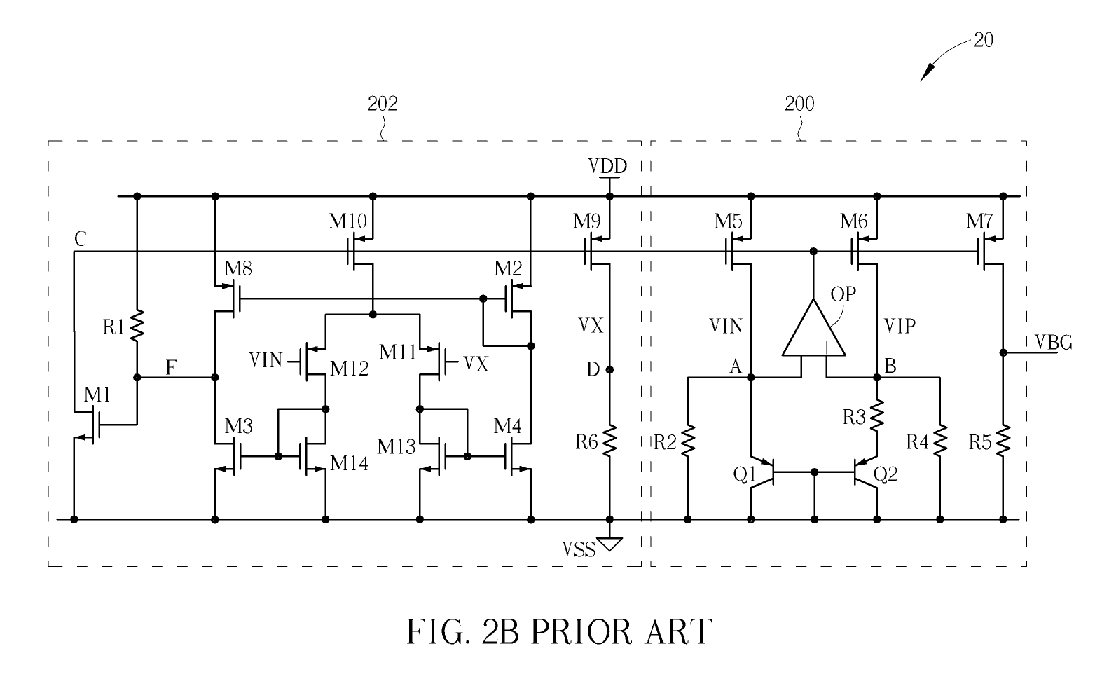

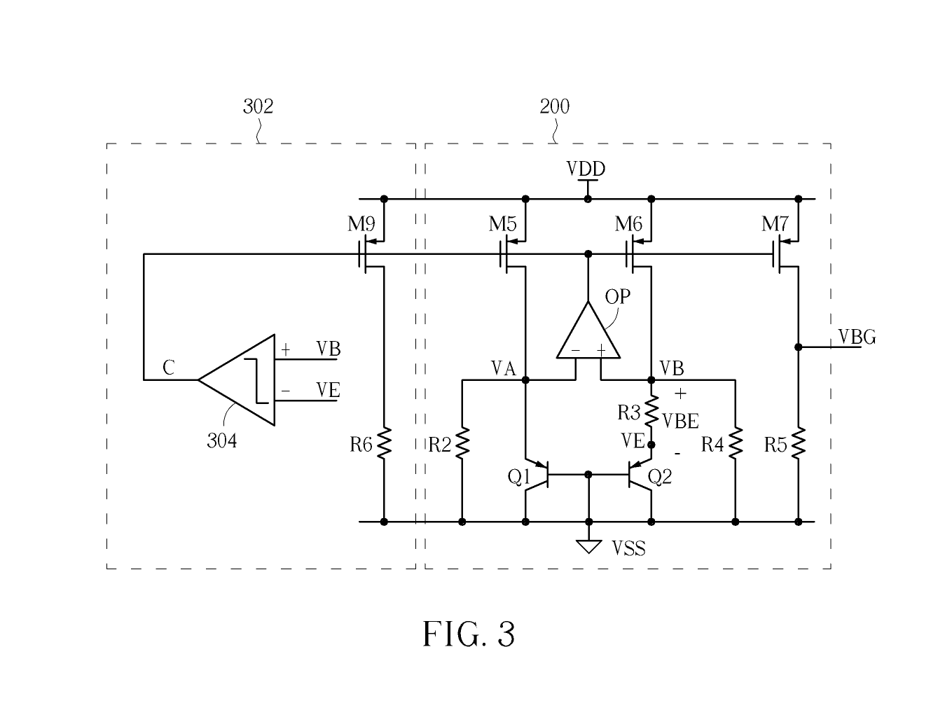

Please refer to FIG. 3, which is a schematic diagram of a start-up circuit 302 according to an embodiment of the present invention. The start-up circuit 302 is used for activating the bandgap voltage generation circuit 200. The bandgap voltage generation circuit 200 comprises a bandgap input end C, a first bandgap output end B and a second bandgap output end E. The first bandgap output end B and the second output end E respectively provide an NTC voltage VB and an NTC voltage VE. Operations and connection relations between elements comprised by the bandgap voltage generation circuit 200 are shown in FIG. 2A. In short, one end of a resistor R3 is the first bandgap output end B, the other end of the resistor R3 coupled to the transistor Q2 is the second bandgap output end E, and an across voltage of the resistor R3 is the voltage difference VBE having a PTC.

Moreover, the start-up circuit 302 comprises a comparator 304, a transistor M9 and a resistor R6. A positive input end of the comparator 304 is coupled to the first bandgap output end B, a negative input end of the comparator 304 is coupled to the second bandgap output end E, an output end of the comparator 304 is used for outputting an output voltage VC. The transistor M9 comprises a gate coupled to the bandgap input end C and the output end of the comparator 304 for receiving the output voltage VC. A source of the transistor M9 is coupled to the system voltage VDD, and a drain of the transistor M9 is coupled to an end of the resistor R6, another end of the resistor R6 is coupled to a system voltage VSS, e.g. a ground.

In operation, when the comparator 304 compares the NTC voltage VB with the NTC voltage VE to output the PTC voltage difference VBE to be substantially equal to zero, i.e. VB−VE=0, the output voltage VC may turn on the transistor M9 to activate the bandgap voltage generation circuit 200. When the comparator 304 compares the NTC voltage VB with the NTC voltage VE to output the PTC voltage difference VBE to be greater than zero, i.e. VB−VE>0, the output voltage VC may turn off the transistor M9, such that the operational amplifier OP of the bandgap voltage generation circuit 200 may control the transistors M9, M5, M6 and M7 to be turned on or off until the bandgap voltage generation circuit 200 has reached the steady state, which means the bandgap voltage generation circuit 200 may operate in an ideal operation region to generate the correct bandgap voltage VBG.

Specifically, in the bandgap voltage generation circuit 200, the transistor Q2 and the resistor R3 may share a common current route to indicate whether there is a current flowing on each other since the resistor R3 is cascaded to the transistor Q2. In another case, when the transistor Q2 is turned on, no current flows on the transistor Q2 nor on the resistor R3. According to Ohm's Law that V=I*R, without a current flowing on the resistor R3, the across voltage VBE of the resistor R3 is zero. In other words, the across voltage VBE of the resistor R3 may indicate whether there is a current flowing on the transistor Q2. A current flowing on the transistor Q2 indicates the bandgap voltage generation circuit 200 may operate in the ideal operation region to generate the correct bandgap voltage VBG.

In short, the start-up circuit 302 may measure whether there is a current flowing on the transistor Q2 to activate the bandgap voltage generation circuit 200 and turn off the start-up circuit 302, such that the bandgap voltage generation circuit 200 may generate the correct bandgap voltage VBG to an output load. When the PTC voltage VBE of the resistor R3 is greater than zero, which indicates there is a current flowing on the resistor R3 and the transistor Q2, the start-up circuit 302 may activate the bandgap voltage generation circuit 200 accordingly.

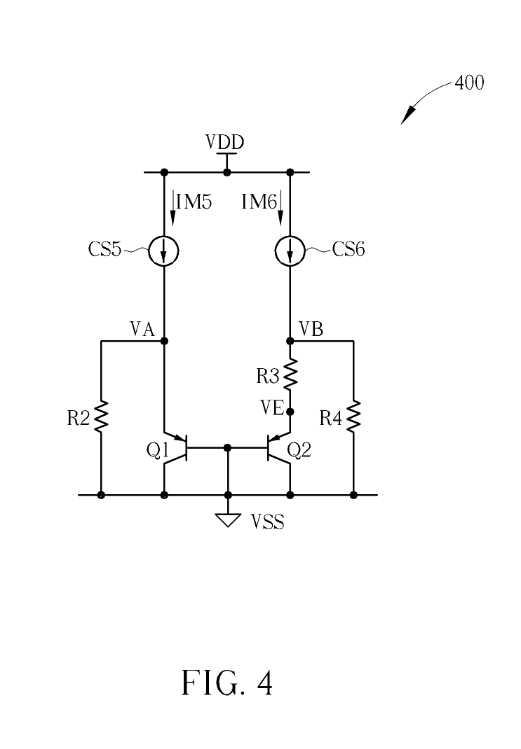

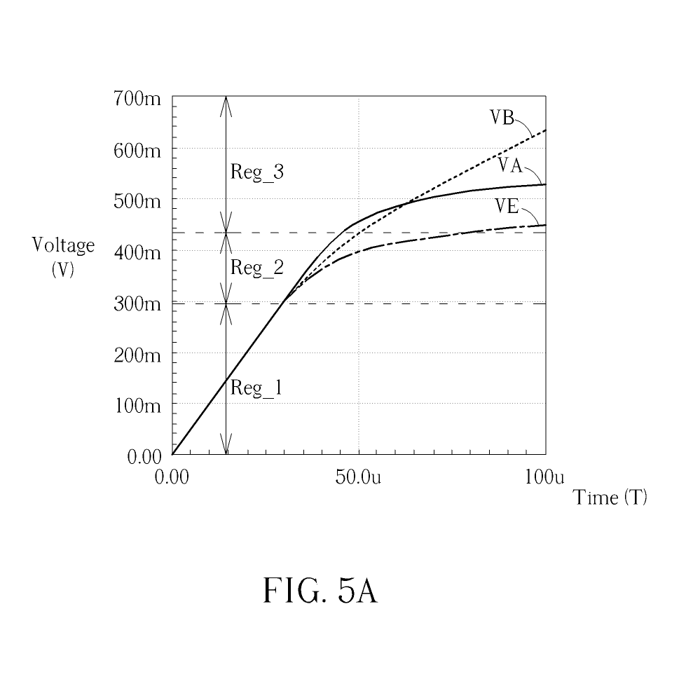

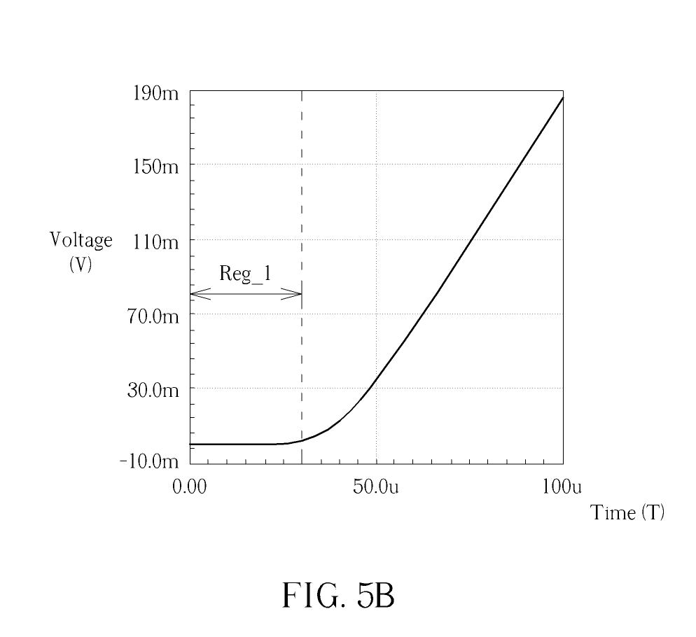

Please refer to FIG. 4, FIG. 5A, and FIG. 5B, which illustrate how the start-up circuit 302 detects that the bandgap voltage generation circuit 200 is operating in the ideal operation region, and why the bandgap voltage generation circuit 200 may reach different steady states. FIG. 4 is a schematic diagram of a bandgap voltage generation circuit 400. For purpose of simply describing operations of bandgap voltage generation circuit 400, the transistors M5, M6 and the operational amplifier OP of bandgap voltage generation circuit 200 are substituted with current sources CS5 and CS6 to respectively generate currents IM5 and IM6. FIG. 5A is a voltage-time diagram of the NTC voltages VA, VB, VE on the nodes A, B and E as the currents IM5 and IM6 increase. The NTC voltage VA is denoted with a solid line, the NTC voltage VB is denoted with a dotted line, and the NTC voltage VE is denoted with a dash line. FIG. 5B is a voltage-time diagram of the PTC voltage difference VBE between the NTC voltage VB and the NTC voltage.

As shown in FIG. 5A, during the bandgap voltage generation circuit 400 generates the bandgap voltage VBG, three operation regions Reg1-Reg3 of the bandgap voltage generation circuit 400 may be divided corresponding to voltage variations of the NTC voltages VA, VB and VE. In the operation region Reg_1, the currents IM5 and IM6 start increasing from zero, and the NTC voltages VA and VB start increasing from zero with a same rising slope. The transistors Q1 and Q2 are turned off since the NTC voltages VA and VB are less than turn-on voltages of the transistors Q1 and Q2. The currents IM5 and IM6 respectively flow into the resistors R2, R4, wherein the rising slopes of the NTC voltages VA and VB are resistances of the resistors R2, R4. Noticeably, in the operation region Reg_1, the start-up circuit 302 is preferably configured to keep turned on to activate the current sources CS5 and CS6, i.e. the transistors M5 and M6 and thereby gradually increase the currents IM5 and IM6. If the start-up circuit is turned off in the operation region Reg_1, the current sources CS5 and CS6 may not charge the resistors R2 and R4 to increase the NTC voltages VA and VB, such that the bandgap voltage generation circuit 400 may stay in the operation region Reg_1 to output the wrong bandgap voltage VBG. Such a wrong steady state should be avoid. In short, when the PTC voltage difference VBE between the NTC voltage VB and the NTC voltage VE is substantially equal to zero, the bandgap voltage generation circuit 200 may operate in a non-ideal operation region Reg_1.

When the bandgap voltage generation circuit 400 enters the operation region Reg_2, since an emitter area of the transistor Q2 is greater than that of the transistor Q1, the transistor Q2 may be turned on earlier than the transistor Q1. The rising slope of the NTC voltage VB and a rising slope of the NTC voltage VE become flatter, and the PTC voltage difference VBE increases as the current 16 increases. On the other hand, the transistor Q1 remains turned off and the rising slope of the NTC voltage VA remains the same. When the bandgap voltage generation circuit 400 enters the operation region Reg_3, the transistor Q1 is turned on and the rising slope of the NTC voltage VA becomes flatter. Meanwhile, the transistor Q2 is fully turned on, and the rising slope of the NTC voltage VB is a constant, i.e. a summation of the resistance of the resistor R3 and an internal resistance of the transistor Q2. After the NTC voltage VA increases to the NTC voltage VB, i.e. VA=VB, the bandgap voltage generation circuit 400 reaches the correct steady state to output the correct bandgap voltage VBG.

As shown in FIG. 5B, when the bandgap voltage generation circuit 400 operates in the operation region Reg_1, the PTC voltage difference VBE is zero, which indicates the transistor Q2 is turned off, the start-up circuit can preferably keep the current sources CS5 and CS6 turned on, to increase the NTC voltages VA and VB. Accordingly, the transistors Q2 and Q1 are sequentially turned, causing the bandgap voltage generation circuit 400 to leave the steady operation region Reg_1. After the transistors Q2 and Q1 are fully turned on, the bandgap voltage generation circuit 400 may transit from the operation region Reg_2 into the ideal operation region Reg_3 to reach the correct steady state and generate the correct bandgap voltage VBG. In short, when the PTC voltage difference VBE is greater than zero, the bandgap voltage generation circuit 200 may leave the wrong steady operation region Reg_1 and enter the operation region Reg_2 and the following ideal operation region Reg_3.

Noticeably, once the bandgap voltage generation circuit enters the operation region Reg_2, the start-up circuit 302 is preferably configured to be turned off immediately, such that the operational amplifier OP may control amounts of the currents IM5 and IM6 flowing on the transistors M5, M6, which may prevent the start-up circuit 302 from applying an improper bias to the bandgap voltage generation circuit 200. For example, the start-up circuit 302 may further include a switch for turning off itself after the bandgap voltage generation circuit has left the operation region Reg_1 and entered the operation region Reg_2.

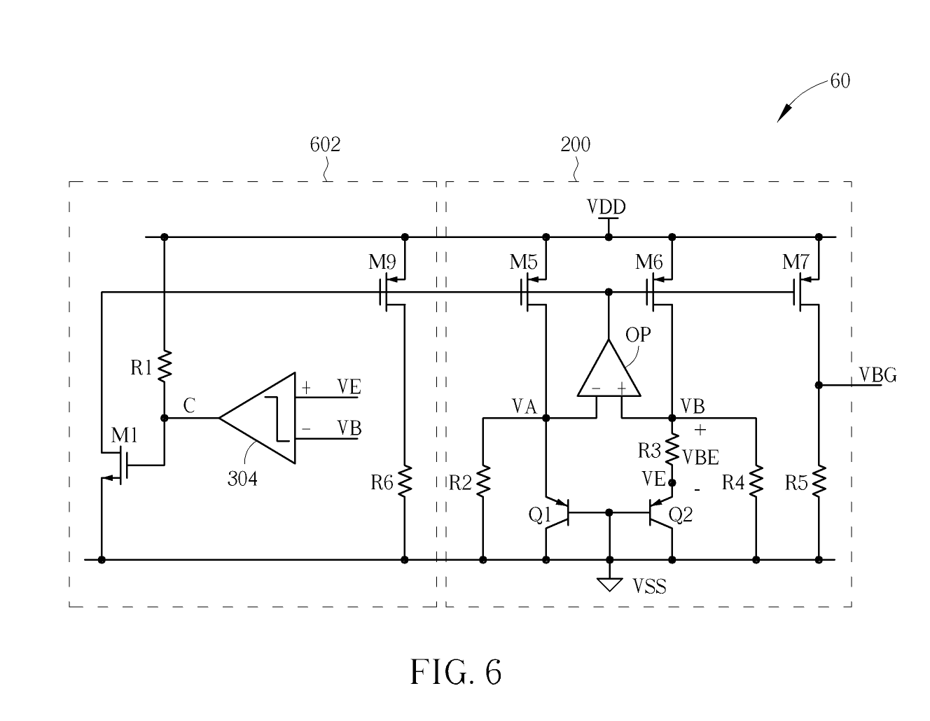

Please refer to FIG. 6, which is a schematic diagram of a bandgap voltage generation device 60 according to an embodiment of the present invention. The bandgap voltage generation device 60 comprises the bandgap voltage generation circuit 200 and a start-up circuit 602. The start-up circuit 602 further includes a transistor M1 and a resistor R1. The resistor R1 is coupled to the system voltage VDD and a gate of the transistor M1, a drain of the transistor M1 is coupled to the gates of the transistors M9, M5, M6 and M7, a source of the transistor M1 is coupled to the system voltage VSS. The positive and negative input ends of the comparator 304 of the start-up circuit 602 are respectively coupled to the second bandgap output end E and the first bandgap output end B, and the output end of the comparator 304 is coupled between the gate of the transistor M1 and the resistor R1. The transistor M1 plays a role of a switch for turning on or off the start-up circuit 602.

In operation, when the comparator 304 compares the NTC voltage VB with the NTC voltage VE to find the voltage difference VBE substantially zero, i.e. VB=VE, the resistor R1 may weakly turn on the transistor M1, such that gate voltages of the transistors M9, M5, M6 and M7 are weakly pulled down, and the transistors M9, M5, M6 and M7 are weakly turned on to activate the bandgap voltage generation circuit 200. Then, when the comparator 304 compares the NTC voltage VB with the NTC voltage VE to find the voltage difference VBE be greater than zero, i.e. VB>VE, which indicates the bandgap voltage generation circuit 200 has left the operation region Reg_1 and enters the operation region Reg_2, the comparator 304 outputs a voltage to turn off the transistor M1 so as to turn off the start-up circuit 602. As a result, the gate voltage of the transistors M9, M5, M6 and M7 may be controlled by the operational amplifier OP of the bandgap voltage generation circuit 200, to ensure that the bandgap voltage generation circuit 200 may operate properly without being influenced by the start-up circuit 602.

To sum up, the traditional start-up circuit may misjudge that the bandgap voltage generation circuit is operating in the wrong steady state, which may lead the bandgap voltage generation circuit to generate a wrong bandgap voltage. In comparison, the start-up circuit of the embodiments may determine whether the bandgap voltage generation circuit has left the wrong steady state by measuring the across voltage, i.e. the PTC voltage difference VBE (e.g., the voltage across the resistor R3 cascaded to the transistor Q2) to activate the bandgap voltage generation circuit and turn off the start-up circuit. As a result, the bandgap voltage generation circuit may generate the desired and correct bandgap voltage to the output load.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A start-up circuit for activating a bandgap voltage generation circuit comprising a bandgap input end, a first bandgap output end for providing a first negative temperature coefficient voltage and a second bandgap output end for providing a second negative temperature coefficient voltage, the start-up circuit comprising:
a comparator comprising a first input end coupled to the first bandgap output end, a second input end coupled to the second bandgap output end, and an output end for outputting an output voltage;
a first transistor comprising a gate coupled to the bandgap input end, a first source/drain coupled to a first system voltage, wherein a voltage of the gate is generated according to the output voltage; and
a first resistor comprising an end coupled to a second source/drain of the first transistor, another end coupled to a second system voltage.

2. The start-up circuit of claim 1, further comprising:
a second transistor comprising a gate coupled to the output end of the comparator, a first source/drain coupled to the gate of the first transistor, and a second source/drain coupled to the second system voltage; and
a second resistor comprising an end coupled to the first system voltage, another end coupled to the output end of the comparator.

3. The start-up circuit of claim 1, wherein the gate of the first transistor is directly connected to the output end of the comparator.

4. The start-up circuit of claim 1, wherein when a voltage difference between the first input end and the second input end is substantially equal to zero, the output voltage of the comparator turns on the first transistor.

5. The start-up circuit of claim 1, wherein when a voltage difference between the first input end and the second input end is greater than zero, the output voltage of the comparator turns off the first transistor.

6. A bandgap voltage generation device, comprising:
a bandgap voltage generation circuit comprising a bandgap input end, a first bandgap output end for providing a first negative temperature coefficient voltage and a second bandgap output end for providing a second negative temperature coefficient voltage; and
a start-up circuit comprising:
a comparator comprising a first input end coupled to the first bandgap output end, a second input end coupled to the second bandgap output end, and an output end for outputting an output voltage;
a first transistor comprising a gate coupled to the bandgap input end, a first source/drain coupled to a first system voltage, wherein a voltage of the gate is generated according to the output voltage; and
a first resistor comprising an end coupled to a second source/drain of the first transistor, another end coupled to a second system voltage.

7. The bandgap voltage generation device of claim 6, wherein the start-up circuit further comprises:
a second transistor comprising a gate coupled to the output end of the comparator, a first source/drain coupled to the gate of the first transistor, and a second source/drain coupled to the second system voltage; and
a second resistor comprising an end coupled to the first system voltage, another end coupled to the output end of the comparator.

8. The bandgap voltage generation device of claim 6, wherein the gate of the first transistor is directly connected to the output end of the comparator.

9. The bandgap voltage generation device of claim 6, wherein when a positive temperature coefficient voltage difference between the first negative temperature coefficient voltage and the second negative temperature coefficient voltage is substantially equal to zero, the output voltage of the comparator turns on the first transistor to activate the bandgap voltage generation circuit.

10. The bandgap voltage generation device of claim 6, wherein when a positive temperature coefficient voltage difference between the first negative temperature coefficient voltage and the second negative temperature coefficient voltage is substantially equal to zero, the bandgap voltage generation circuit operates in a non-ideal operation region.

11. The bandgap voltage generation device of claim 6, wherein when a positive temperature coefficient voltage difference between the first negative temperature coefficient voltage and the second negative temperature coefficient voltage is greater than zero, the output voltage of the comparator turns off the first transistor to deactivate the bandgap voltage generation circuit.

12. The bandgap voltage generation device of claim 6, wherein when the bandgap voltage generation circuit operates in an ideal operation region, a positive temperature coefficient voltage difference between the first negative temperature coefficient voltage and the second negative temperature coefficient voltage is greater than zero.

13. A bandgap voltage generation device, comprising:
a bandgap voltage generation circuit comprising a bandgap input end, a first bandgap output end for providing a first negative temperature coefficient voltage, and a second bandgap output end for providing a second negative temperature coefficient voltage; and
a start-up circuit coupled to the first bandgap output end and the second bandgap output end for activating the bandgap voltage generation circuit when a positive temperature coefficient voltage difference between the first negative temperature coefficient voltage and the second negative temperature coefficient voltage is determined to be zero.

14. The bandgap voltage generation device of claim 13, wherein when the positive temperature coefficient voltage difference is substantially equal to zero, the bandgap voltage generation circuit operates in a non-ideal operation region.

15. The bandgap voltage generation device of claim 13, wherein when the bandgap voltage generation circuit operates in an ideal operation region, the positive temperature coefficient voltage difference is greater than zero.

16. The bandgap voltage generation device of claim 13, wherein the start-up circuit comprises:
a comparator comprising a first input end coupled to the first bandgap output end, a second input end coupled to the second bandgap output end and an output end;
a first transistor comprising a gate coupled to the bandgap input end, a first source/drain coupled to a first system voltage, wherein a voltage of the gate is generated according to the output voltage; and
a first resistor comprising an end coupled to a second source/drain of the first transistor, another end coupled to a second system voltage.

17. The bandgap voltage generation device of claim 16, wherein the start-up circuit further comprises:
a second transistor comprising a gate coupled to the output end of the comparator, a first source/drain coupled to the gate of the first transistor, and a second source/drain coupled to the second system voltage; and
a second resistor comprising an end coupled to the first system voltage, another end coupled to the output end of the comparator.

18. The bandgap voltage generation device of claim 16, wherein the gate of the first transistor is directly connected to the output end of the comparator.

19. The bandgap voltage generation device of claim 16, wherein when the positive temperature coefficient voltage difference is substantially equal to zero, the output voltage of the comparator turns on the first transistor.

20. The bandgap voltage generation device of claim 13, wherein when the positive temperature coefficient voltage difference is greater than zero, the output voltage of the comparator turns off the first transistor.
